(19) United States
(12) Patent Application Publication
(10) Pub. No.: US 2015/0044465 A1
(43) Pub. Date: Feb. 12, 2015

(54) FLUX FOR RESIN CORED SOLDER AND RESIN CORED SOLDER

(71) Applicants: FUJI ELECTRIC CO., LTD., Kawasaki-shi (JP); FUJI ELECTRIC FA COMPONENTS & SYSTEMS CO., LTD., Tokyo (JP)

(72) Inventors: Tatsuya GANBE, Asaka-city (JP); Hirohiko WATANABE, Hachioji-city (JP)

(21) Appl. No.: 14/330,718

(22) Filed: Jul. 14, 2014

(30) Foreign Application Priority Data
Aug. 9, 2013 (JP) 2013-166281

(51) Int. Cl. B23K 35/36; B23K 35/02; B23K 35/26

(52) U.S. Cl. CPC B23K 35/3613; B23K 35/3616; B23K 35/262; B23K 35/0227
USPC 428/378; 148/23; 57/258; 139/387 R

(57) ABSTRACT

A flux for resin cored solder containing a thermosetting resin is disclosed which is excellent in storage stability and productivity, and a resin cored solder having the flux built in. The flux for resin cored solder comprises a solid-state first flux containing a thermosetting resin, and a solid-state second flux containing a curing agent having redox activity, the first flux and the second flux being present in a non-contact state. A resin cored solder comprises the flux for resin cored solder and a lead-free solder alloy having a melting point ranging from 130° C. to 250° C. The resin cored solder is made up of a first resin cored solder in which the first flux is built into the lead-free solder alloy, and a second resin cored solder in which the second flux is built into the lead-free solder alloy.

### BACKGROUND OF THE INVENTION

A. Field of the Invention

The present invention relates to a flux for resin cored solder and to a resin cored solder that contains the flux. In particular, the present invention relates to a flux for resin cored solder that is used for repair or hand-soldering of electronic components and that allows reinforcing joint strength in the components without the need for cleaning flux residue, and relates to a resin cored solder that contains the flux.

B. Description of the Related Art

In many soldering fluxes, an activator made of an organic acid, a halide salt or a halogen compound is added to a rosin or rosin-modified resin. These components, however, remain on printed circuit boards in the form of residue once the soldering operation is over. Such residue often constitutes a cause of base material corrosion, migration and the like. If a printed circuit board having some residue remaining thereon is sealed with a resin such as silicone gel, an epoxy resin or the like, the flux residue after the soldering operation may hinder curing of the sealing resin, and may affect the adhesiveness with the board and the insulation properties. Therefore, cleaning with CFC substitutes or organic solvents is performed after the soldering operation, in order to remove the residue. Cleaning agents, however, are restricted on account of environmental issues related to CFCs, volatile organic compounds (VOCs) and the like.

Epoxy-based fluxes that utilize epoxy resins are one known instance of fluxes that do not give rise to corrosion or migration and that do not hinder curing of the sealing resin, even without cleaning of the flux residue. Known conventional epoxy-based fluxes include cream solders made up of an epoxy resin, as a main component, an organic acid or amine, being a curing agent or activator, and an alcohol-based solvent (Japanese Patent Application Publication No. 2000-216300). In cases where components are mounted on a printed board using a cream solder that utilizes an epoxy-based flux, the flux is designed in such a manner that, upon reflow soldering, curing reactions between the epoxy resin and the carboxylic acid occur and solder melts simultaneously with removal of the oxide film derived from the carboxylic acid on the conductor surface, and in such a manner that the curing reaction ends once soldering is over. The epoxy resin cured product remains after soldering in the form of flux residue. Compared with residues of ordinarily used rosin-based fluxes, this epoxy resin does not hamper adhesiveness between a sealing resin and the printed circuit board even if component soldering is followed by resin sealing without cleaning; moreover, the epoxy resin has excellent insulation properties.

Other known resin cored solders include solder wires having an epoxy resin-based flux core, i.e., resin cored solders having an inner core in the form of a flux made of a reactive epoxy resin, an activator, an epoxy curing agent and a thixotropic agent, and having an outer shell of a solder alloy (Japanese Translation of PCT Application No. 2002-514973).

The present invention is directed to overcoming or at least reducing the effects of one or more of the problems set forth above.

### SUMMARY OF THE INVENTION

When producing a resin cored solder using thermosetting resin-based fluxes, heat is generated in the processes of resin coring, drawing and so forth that are involved in ordinary production methods. In fluxes that contain a thermosetting resin, a thermosetting resin base and an organic acid that is used as the curing agent are mixed together, and, as a result, the resin may in some instances undergo curing on account of heat in the course of the production processes. The resin cored solder, moreover, is ordinarily stored while left at room temperature, at the site of actual use. In this case as well, the thermosetting resin base and the curing agent may in some instances react slowly as time wears on, giving rise to the problem of shortened storage time.

In light of the above problems, the inventors envisaged the production of a resin cored solder configured separately out of a thermosetting resin base and a curing agent. Specifically, the inventors found that a resin cored solder can be produced, without triggering curing of a thermosetting resin, by separately configuring the resin cored solder out of a thermosetting resin base and a curing agent, in such a manner that the thermosetting resin base and the curing agent do not come into contact until the time of use, and by wire-twisting and bundling together wires of the resulting resin cored solder. The inventors perfected the present invention on the basis of that finding.

In one embodiment, the present invention is a flux for resin cored solder, comprising a solid-state first flux containing a thermosetting resin base, and a solid-state second flux containing a curing agent having redox activity, wherein the first flux and the second flux are present in a non-contact state.

In the flux for resin cored solder, preferably, the flux for resin cored solder comprises one first flux or more and one second flux or more.

In the flux for resin cored solder, preferably, the first flux and the second flux are individually covered, at least partially, with a lead-free solder alloy.

In the flux for resin cored solder, preferably, the partially covered first flux and second flux are bundled or twisted.

In the flux for resin cored solder, preferably, the melting point of the thermosetting resin ranges from 50 to 150° C.

In the flux for resin cored solder, preferably, the thermosetting resin is an epoxy resin selected from the group consisting of bisphenol A epoxy resins, bisphenol F epoxy resins, novolac epoxy resins, alicyclic epoxy resins, and mixtures of the foregoing.

In the flux for resin cored solder, preferably, the curing agent having redox activity is selected from the group consisting of amines, halogenated amine salts, halogenated organic acid salts, halogen compounds, organic acids, acid anhydrides, phenolic resins, and mixtures of the foregoing.

In the flux for resin cored solder, preferably, an equivalent ratio of the thermosetting resin base and the curing agent ranges from 1:0.8 to 1.3.

In another embodiment, the present invention is a resin cored solder, containing any one of the above fluxes for resin cored solder, and a lead-free solder alloy, wherein the resin cored solder is made up of a first resin cored solder in which the first flux is built into the lead-free solder alloy, and a second resin cored solder in which the second flux is built into the lead-free solder alloy.

In the resin cored solder, preferably, the first resin cored solder and the second resin cored solder are separate linear solders.

In the resin cored solder, preferably, the first resin cored solder and the second resin cored solder are bundled, twisted or woven.

In the resin cored solder, preferably, one or more of the first resin cored solders and one or more of the second resin cored solders are fixed the portions of the lead-free solder alloy, so as to constitute one wire of a multi-core resin cored solder.

In any one of the above resin cored solders, preferably, the lead-free solder alloy is a Sn-containing lead-free solder alloy having a melting point ranging from 130 to 250° C.

The flux for resin cored solder of the present invention elicits the effect of undergoing no degradation on account of heat released in the production processes of a resin cored solder or on account of the temperature conditions during storage, and being easy to handle, and the effect of making it possible to reinforce the joint strength of electronic components, without the need for cleaning flux residue, when the flux is used together with solder. Further, reliable electrical contact between conductors is secured, thanks to the high insulation properties of the thermosetting resin, and a film of excellent adhesiveness can be formed also in case of resin sealing, without cleaning, after soldering. The flux for resin cored solder is made up of a solid-state first flux containing a thermosetting resin and a solid-state second flux containing a curing agent having redox activity, such that the first flux and the second flux are present separately and in a non-contact state. As a result, the proportion of thermosetting resin and curing agent can be easily modified during use.

### BRIEF DESCRIPTION OF THE DRAWINGS

The foregoing advantages and features of the invention will become apparent upon reference to the following detailed description and the accompanying drawings, of which:

FIG. 1 is a conceptual diagram illustrating a flux for resin cored solder according to one embodiment of the present invention;

FIGS. 2A and 2B are a set of diagrams illustrating a first flux that makes up a flux for resin cored solder according to one embodiment of the present invention, wherein FIG. 2A is a plan-view diagram of a linear resin cored solder, and FIG. 2B is an A-A cross-sectional diagram of FIG. 2A;

FIGS. 3A and 3B are a set of diagrams illustrating a first flux that makes up a flux for resin cored solder according to a first embodiment of the present invention, wherein FIG. 3A is a plan-view diagram of a linear resin cored solder, and FIG. 3B is a B-B cross-sectional diagram of FIG. 3A;

FIG. 4 is a diagram illustrating a bundled linear resin cored solder that contains a flux for resin cored solder according to one embodiment of the present invention;

FIG. 5 is a diagram illustrating another bundled linear resin cored solder that comprises a flux for resin cored solder according to one embodiment of the present invention;

FIGS. 6A and 6B are a set of diagrams illustrating yet another bundled linear resin cored solder that contains a flux for resin cored solder according to one embodiment of the present invention, wherein FIG. 6A is a perspective-view diagram of a linear resin cored solder, and FIG. 6B is a C-C cross-sectional diagram of FIG. 6A;

FIG. 7 is a diagram illustrating a twisted linear resin cored solder that contains a flux for resin cored solder according to a first embodiment of the present invention;

FIG. 8 is a diagram illustrating a woven linear resin cored solder that contains a flux for resin cored solder according to one embodiment of the present invention; and

FIGS. 9A and 9B are a set of diagrams illustrating a spherical resin cored solder that contains a flux for resin cored solder according to one embodiment of the present invention.

### DETAILED DESCRIPTION OF SPECIFIC EMBODIMENTS

The present invention will be explained next in detail by way of embodiments. The explanation below merely illustrates the present invention, and does not limit the invention in any way.

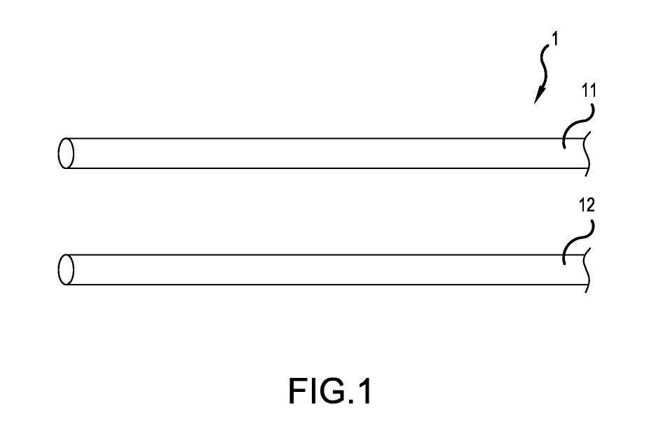

In a first embodiment, the present invention is a flux for resin cored solder. FIG. 1 is a conceptual diagram for explaining a flux for resin cored solder 1 according to the present embodiment. The flux for resin cored solder according to the present embodiment is made up of a first flux 11 and a second flux 12. As illustrated in the figure, the first flux 11 and the second flux 12 are separate solid-state fluxes that are present in a state such that they do not contact each other.

The first flux 11 is a solid-state flux containing a thermosetting resin base. In the present description, the term solid-state denotes the property of being solid under conditions of normal temperature and normal pressure, in particular, the property of having a melting point of 50° C. or higher. The first flux 11 contains mainly a base of a thermosetting resin, and may contain additives in small amounts. Preferably, the first flux 11 is made up of only the base of a thermosetting resin. The purpose of this restriction is to minimize the amount of substances that may influence a substrate in any way, such as a printed circuit board, after use of the first flux 11 together with a lead-free solder alloy. The first flux 11 contains substantially no substance that can function as a curing agent of the base of a thermosetting resin, and no substance that reacts with the base of a thermosetting resin. Such a first flux contains mainly a resin base component, from among components of conventional fluxes that jointly contain a resin base and a curing agent. The first flux may be referred to as flux base component.

Specific examples of the base of a thermosetting resin include, although not limited thereto, epoxy resins and the like. A preferred base of an epoxy resin is herein solid under conditions of normal temperature and normal pressure, has a melting point ranging from 50 to 150° C., preferably from 70 to 145° C., and is cured by a below-described curing agent having redox activity. Examples of such base of an epoxy resin include, but are not limited thereto, bisphenol A epoxy resins, bisphenol F epoxy resins, novolac epoxy resins, alicyclic epoxy resins, and mixtures of the foregoing. Preferably, the epoxy resin has an epoxy equivalent ranging from 150 to 4000 g/eq.

The first flux 11 in the present embodiment may contain optional additives. Examples of additives include, for instance, thixotropic agents, chelating agents, defoamers, surfactants and antioxidants. The content of thixotropic agent may be 5 mass % or less, the content of chelating agent 5 mass % or less, the content of defoamer 1 mass % or less, the content of surfactant 2 mass % or less, and the content of antioxidant 3 mass % or less, with respect to the total mass of the flux. The total mass of the flux denotes herein the mass resulting from totaling the first flux 11 plus the second flux 12.

For instance, the thixotropic agent, being an example of an additive, imparts viscosity to the thermosetting resin base, and is advantageous in the present embodiment in terms of conferring a suitable melting point to the first flux. However, the thixotropic agent need not be present as an essential constituent component. Ordinary thixotropic agents that are used in fluxes can be utilized herein as the thixotropic agent. Specific examples thereof include, although not limited thereto, castor oil, hydrogenated castor oil and the like.

The first flux 11 is typically linear, but is not limited to a specific shape, and also may be rod-like, plate-like or spherical. The first flux 11 may be linear, having a diameter of, for instance, 0.01 to 2.0 (mm), preferably 0.3 to 0.8 (mm), and most preferably 0.05 to 0.3 (mm). Alternatively, the first flux may be produced and distributed as a preform, in which case the first flux can be worked to a desired shape together with the lead-free solder alloy.

The first flux 11 will be explained next from the viewpoint of a production method thereof. The method for producing the first flux 11 comprises a step of selecting a base of a thermosetting resin that is solid at normal temperature and normal pressure, and a step of molding the base of a thermosetting resin to a specific shape. A thermosetting resin having a melting point ranging from 50 to 150° C., and preferably from 70 to 145° C., as described above, and that is cured using a below-described curing agent having redox activity, can be selected herein in the step of selecting a base of a thermosetting resin that is solid at normal temperature and normal pressure. The step of molding the base of a thermosetting resin to a specific shape is carried out in accordance with an ordinary method. For instance, the base of a thermosetting resin can be molded to yield a linear flux having a specific diameter, through drawing of the base of a thermosetting resin, alone, or together with a below-described lead-free solder alloy. In the case of a preform, alternatively, the preform is produced by resorting to an ordinary method, in accordance with the intended purpose and intended use.

The first flux 11 is kept in a state of not coming into contact with the below-described second flux 12 until the time of use. Specifically, the first flux 11 is kept in a state where a specific shape of the first flux 11 is preserved and the surface thereof is covered with lead-free solder alloy, without occurrence of dripping or the like, under conditions of normal temperature and normal pressure.

The second flux 12 is explained next. The second flux 12 is a solid-state flux containing a curing agent having redox activity. The second flux 12, which contains mainly a curing agent having redox activity, may additionally contain, for instance, the above-described additives. The second flux 12 contains substantially no substances that may function as a base of a thermosetting resin, and no components that react with the curing agent. Such a second flux contains mainly a curing agent, from among components of conventional fluxes that jointly contain a resin base and a curing agent. Accordingly, the second flux may be also referred to as a flux curing agent component.

Preferably, the curing agent that constitutes a main component of the second flux 12 is solid at normal temperature and normal pressure, and has redox activity towards metal oxides that derive from lead-free solder alloys and from the object to be soldered. That is, the curing agent has the property of combining the effect of curing the base of a thermosetting resin that is the main component of the first flux 11, and the effect of functioning as an oxide-removing activator in the flux. Compounds that constitute the curing agent include, but are not limited thereto, amines, halogenated amine salts, halogenated organic acid salts, halogen compounds, organic acids, acid anhydrides, phenolic resins, and mixtures of the foregoing. Particularly preferred are curing agents having a melting point of 130° C. or higher.

Organic acids, in particular organic carboxylic acids, are an example of curing agents for an epoxy resin base. Organic carboxylic acids are consumed in the curing reaction with the epoxy resin, or in reactions with a sealing resin, and hence can be used without flux cleaning. As the organic carboxylic acid there can be used preferably, bifunctional or higher organic carboxylic acids, for instance, saturated aliphatic dicarboxylic acids, unsaturated aliphatic dicarboxylic acids, cyclic aliphatic dicarboxylic acids, aromatic dicarboxylic acids, amino group-containing carboxylic acids, hydroxyl group-containing carboxylic acids and heterocyclic dicarboxylic acids, as well as mixtures of the foregoing.

Further specific examples include saturated aliphatic dicarboxylic acids such as succinic acid, glutaric acid, adipic acid, azelaic acid and dodecanedioic acid; unsaturated aliphatic dicarboxylic acids such as itaconic acid and mesaconic acid; cyclic aliphatic carboxylic acids such as cyclobutane dicarboxylic acid, cyclohexane dicarboxylic acid, cyclohexane dicarboxylic acid and cyclopentane tetracarboxylic acid; saturated aliphatic dicarboxylic acids having a side chain, such as dimethyl glutaric acid and methyl adipic acid; amino group-containing carboxylic acids such as glutamic acid and ethylenediaminetetraacetic acid; hydroxyl-containing carboxylic acids such as citric acid, malic acid and tartaric acid; and heterocyclic dicarboxylic acids such as pyrazine dicarboxylic acid; and also, phenylene diacetic acid, catechol diacetic acid, hydroquinone diacetic acid, thiopropionic acid, thiodibutyric acid, dithioglycolic acid, as well as mixtures of the foregoing. In terms of improving various characteristics, for instance enhancing solder wettability, storage stability, and insulation properties of a flux cured product, the organic carboxylic acid is preferably selected from the group consisting of cyclohexene dicarboxylic acid, dimethyl glutaric acid, glutamic acid, phthalic acid, itaconic acid, and mixtures of the foregoing.

Preferably, the curing agent is selected based on the relationship thereof with the base of a thermosetting resin. Herein a person skilled in the art can select appropriate combinations in accordance with the intended purpose and application.

The additives as optional components explained for the first flux 11 may be contained in the second flux 12. In this case, the total mass of additives contained in the first flux 11 and the second flux 12 lies preferably within the above-described content range with respect to the total mass of flux.

As illustrated in the figures, the shape of the second flux 12 can be identical to that of the first flux 11. For instance, the second flux 11 as well may be linear in a case where the first flux 11 is linear. In this case, the diameter and length of wires can be set by a person skilled in the art in accordance with the method of usage, and may be set to identical diameters and identical lengths, or to specific ratios thereof. Although not depicted in the figures, the second flux also can be spherical if the first flux is spherical. Alternatively, the second flux may be produced as a preform if the first flux is a preform.

To produce the second flux 12, ordinarily a curing agent that is present as a solid may be melted, followed by molding to a specific shape, in accordance with an ordinary method.

The second flux 12 is kept in a state of not being in contact with the first flux 11 until the time of use for soldering. Specifically, the second flux 12 is kept in a state where a specific shape of second flux 12 is preserved and the surface thereof is covered with lead-free solder alloy, under conditions of normal temperature and normal pressure.

The flux for resin cored solder according to the present embodiment, which contains the first flux 11 and the second flux 12, will be explained from the viewpoint of the method of use of the flux for resin cored solder. The first flux 11 and the second flux 12 of the flux for resin cored solder according to the present embodiment are built into the lead-free solder alloy, and make up a resin cored solder integrally with the lead-free solder alloy. The flux and the lead-free solder alloy are used together. Therefore, the method of use of the flux for resin cored solder will be explained in detail below along with embodiments of the resin cored solder.

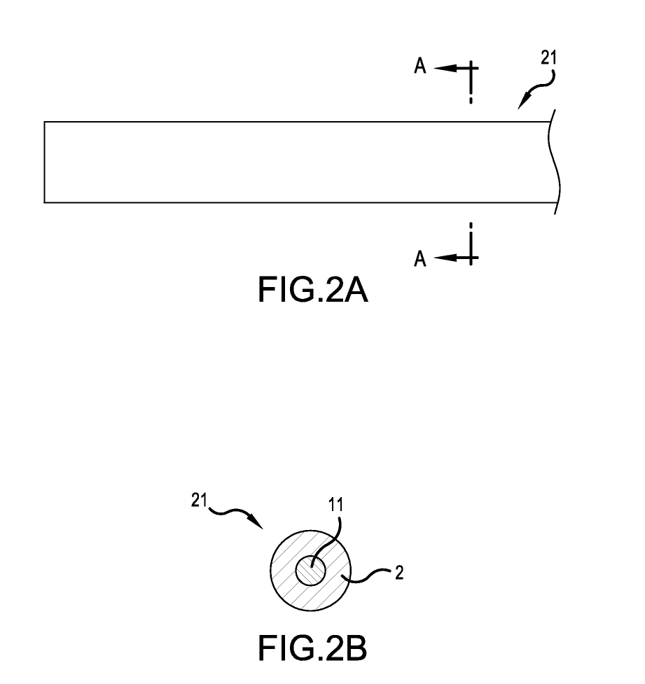

In a first embodiment of the resin cored solder of the present invention, a linear resin cored solder will be explained wherein the flux for resin cored solder according to the present invention is integrally built into the linear resin cored solder. FIGS. 2 to 4 are diagrams for explaining a linear resin cored solder. A linear resin cored solder 100a according to the present embodiment is made up of a first resin cored solder having the first flux 11 built into it and a second resin cored solder having the second flux 11 built into it.

FIG. 2 is a conceptual diagram illustrating the first resin cored solder having the first flux 11 built into it. FIG. 2A is a plan-view diagram or front-view diagram of a first resin cored solder 21. In the first resin cored solder 21, the first flux 11 fills a core section in a linear lead-free solder alloy 2. In other words, the side surface of the linear first flux 11, in the length direction, is covered by the lead-free solder alloy 2. The two end sections of the linear first flux 11 may be covered or not by the lead-free solder alloy 2.

FIG. 2B illustrates an A-A cross-sectional diagram of the first resin cored solder 21. In FIG. 2B, the first flux 11 is present at the core section of the linear first resin cored solder 21, such that the periphery of the first flux 11 is covered by the lead-free solder alloy 2.

The lead-free solder alloy 2 that covers the first flux 11 is preferably a lead-free solder having a melting point ranging from about 150 to 240° C., more preferably a lead-free solder having a melting point ranging from about 210 to 230° C. Herein, lead-free Sn-containing solder having a melting point of about 190 to 240° C. is used in a more preferred embodiment. The Sn-containing lead-free solder may be, for instance, a Sn solder, a Sn—Bi-based solder, a Sn—Ag-based solder, a Sn—Cu-based solder, a Sn—Zn-based solder or a Sn—Sb-based solder (melting point: about 190 to 240° C.). More preferably, the Sn-containing lead-free solder is a Sn—Ag-based solder. The Sn—Ag-based solder may be, for instance, Sn—Ag, Sn—Ag—Cu, Sn—Ag—Bi, Sn—Ag—Cu—Bi, Sn—Ag—Cu—In, Sn—Ag—Cu—S, Sn—Ag—Cu—Ni—Ge or the like. More preferably, the solder is a Sn-3.5Ag-0.5Cu-0.1 Ni-0.05Ge solder or a Sn-3.5Ag-0.5Cu solder.

The content of lead-free solder alloy 2 in the first resin cored solder 21 may be, for instance, 90 mass % or more, or about 90 to 99.9 mass %, and more preferably about 95 to 99 mass %, with respect to the total mass of the first resin cored solder 21. The remaining amount, namely 10 mass % or less, for instance about 0.1 to 10 mass %, preferably about 1 to 5 mass %, can be taken up by the first flux 11.

The method for producing such a first resin cored solder 21 may involve producing a resin cored solder having a thick solder diameter, by combining the lead-free solder alloy and the flux in accordance with an ordinary method, followed by a plurality of drawing processes so as to form wires of specific thickness. The method and equipment for producing the resin cored solder are well known to a person skilled in the art, who could thus arrive at producing the resin cored solder in accordance with an ordinary method.

In FIG. 2, the single-core first resin cored solder 21 is explained for the configuration illustrated in the figure, but the first resin cored solder 21 may be of multi-core type, and a person skilled in the art can decide, as appropriate, to use a multi-core resin cored solder in accordance with the intended purpose and application.

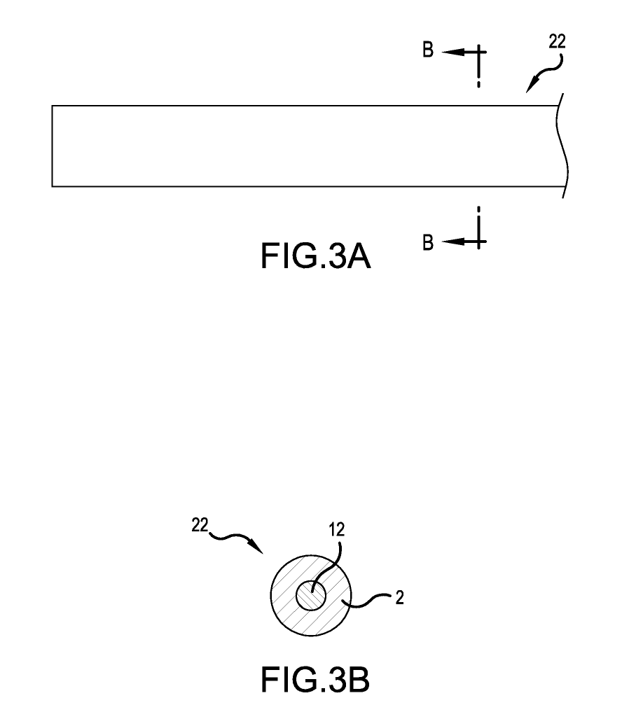

FIG. 3 depicts the second resin cored solder 22. FIG. 3A is a plan-view diagram or front-view diagram of the second resin cored solder 22, and FIG. 3B is a B-B cross-sectional diagram of FIG. 3A. The second resin cored solder 22 as well has the second flux 12 at the core section of the linear resin cored solder, such that the periphery of the second flux 12 is covered by the lead-free solder alloy 2. The second resin cored solder 22 as well is not limited to being of single-core type, and may be of multi-core type.

The same lead-free solder alloys as those explained for the first resin cored solder 21 above can be used herein as the lead-free solder alloy 2. Ordinarily, there can be used the same lead-free solder alloy as that of the first resin cored solder 21. The composition of the lead-free solder alloy, however, is not limited, and depending on the intended application, a lead-free solder alloy may be used that is different from the one that is used in the first resin cored solder 21.

The content of the lead-free solder alloy 2 in the second resin cored solder 22 may be, for instance, of about 90 mass % or more, or about 90 to 99.9 mass %, and more preferably of about 95 to 99 mass %, with respect to the total mass of the second resin cored solder 22. The balance can be set to, for instance, about 0.1 to 10 mass %, preferably about 0.1 to 5 mass %, of the second flux 12.

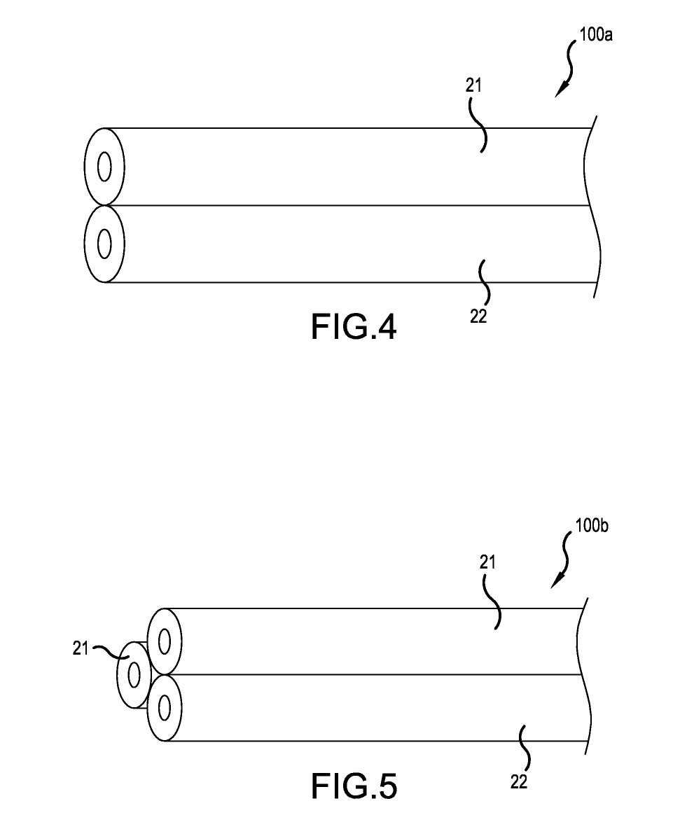

The first resin cored solder 21 and the second resin cored solder 22 may be produced separately, distributed separately, and stored separately, or may alternatively be distributed together, and stored together. The first resin cored solder 21 and the second resin cored solder 22 are used together during soldering. FIG. 4 illustrates a first embodiment of the resin cored solder having the flux for resin cored solder according to the present embodiment built in. The resin cored solder 100a illustrated in FIG. 4 results from combining and bundling one wire each of the linear first resin cored solder 21 and the linear second resin cored solder 22.

In the resin cored solder 100a illustrated in FIG. 4, the linear first resin cored solder 21 and the linear second resin cored solder 22 may be individual separate linear solids, and need not be fixed, as both resin cored solders are bundled. Optionally, however, the first resin cored solder 21 and the second resin cored solder 22 may be partially fixed at the portions of the lead-free solder alloy 2.

Preferably, the mass ratio of the first flux contained in the first resin cored solder 21 and the second flux contained in the second resin cored solder 22 is determined on the basis of the relationship between the reaction equivalent of the epoxy resin that makes up the first flux and the reaction equivalent of the curing agent that makes up the second flux. Specifically, the equivalent ratio of the epoxy resin base that makes up the first flux and the equivalent ratio of the curing agent that makes up the second flux are set to range from 1:0.8 to 1:1.3, more preferably from 1:0.9 to 1:1.2. In the linear resin cored solder 100a illustrated in the figure, where both resin cored solders have the same length, the above equivalent ratios can thus be attained by prescribing the equivalent ratio of the epoxy resin base contained in the first resin cored solder 21 and the equivalent ratio of the curing agent contained in the second resin cored solder 22 to lie within the above ranges. Alternatively, the length of the first resin cored solder 21 and the length of the second resin cored solder 22 can be regulated in such a way so as to allow attaining the above equivalent ratios. Ordinarily, linear resin cored solders are often distributed in single-roll units. Accordingly, if the first resin cored solder 21 and the second resin cored solder 22 are used to a same length, the first resin cored solder 21 and the second resin cored solder 22 are preferably configured so that there is achieved a suitable equivalent ratio of the epoxy resin base that makes up the first flux and the curing agent that makes up the second flux.

The method of use of the resin cored solder 100a illustrated in FIG. 4 may be identical to methods of ordinary resin cored solders, but with the first and the second cored solders used together herein.

FIG. 5 illustrates a conceptual diagram of a resin cored solder according to a second embodiment. A resin cored solder 100b illustrated in FIG. 5 results from combining two wires of the linear first resin cored solder 21 and one wire of the linear second resin cored solder 22, such that the wires have substantially the same length. In the resin cored solder 100b illustrated in FIG. 5, the two wires of the first resin cored solder 21, as well as the second resin cored solder 22, may be individual separate linear solids, and need not be fixed, although the wires may optionally be fixed in part.

The present embodiment is advantageous in that the first resin cored solder 21 and the second resin cored solder 22 are used as individual solids; thereby, an arbitrary wire number ratio, as determined by the user, can be resorted to when using the resin cored solder 100b. The combination in the resin cored solder 100b illustrated in the figure involves one wire of the second resin cored solder 22 for two wires of the first resin cored solder 21, but the resin cored solder 100b is not limited to this wire number ratio. The resin cored solder may be configured out of one wire or a plurality of wires of the first resin cored solder, and one wire or a plurality of wires of the second resin cored solder. The wire number ratio of the number of wires of first resin cored solder 21 and of the second resin cored solder 22 may be, for instance, 3:1, 3:2, 4:1, 4:3 or the like.

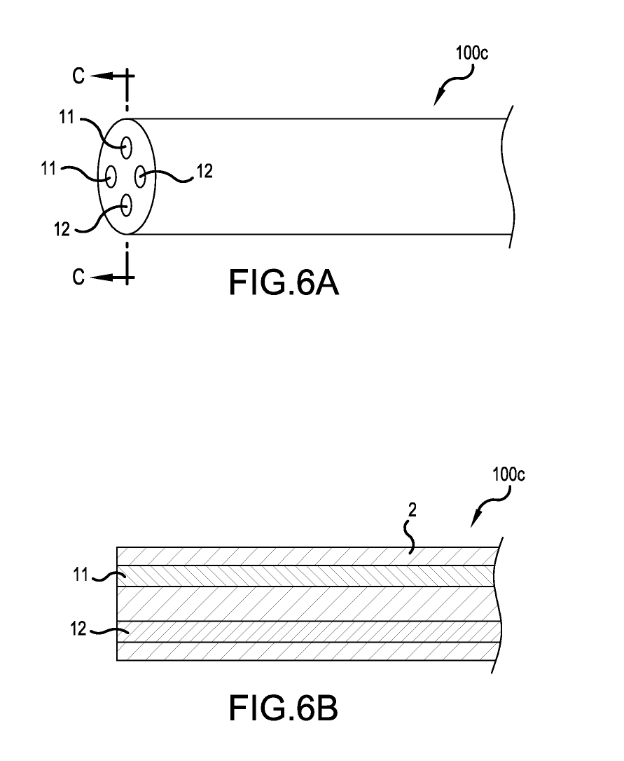

FIG. 6 illustrates a conceptual diagram of a resin cored solder according to a third embodiment. The resin cored solder 100c illustrated in FIG. 6 constitutes a single-wire multi-core resin cored solder where the first flux 11 and the second flux 12 are individually encompassed in one wire of resin cored solder. In this embodiment there is no clear distinction between the first resin cored solder 21 and the second resin cored solder 22. In this configuration, however, one or more first resin cored solders and one or more second resin cored solders are fixed at respective lead-free solder alloy portions. The resin cored solders may also be regarded as constituents that make up one wire of multi-core resin cored solder. In the solder 100c illustrated in FIG. 6, the first flux 11 and the second flux 12 are built into the lead-free solder alloy in a positional relationship such that the first flux 11 and the second flux 12 do not come into contact with each other until the time of use.

In the third embodiment, the compositions of the first and second fluxes, the composition ratio of the thermosetting resin base and the curing agent, and the respective production methods are as described in the embodiment relating to the fluxes. Such a resin cored solder 100c can be produced in accordance with an ordinary method for producing multi-core resin cored solder. The multi-core resin cored solder 100c illustrated in FIG. 6 has two wires each of the first flux 11 and of the second flux 12 built into it, but the number of cores and the core number ratio are not limited to specific values. The number of cores and the core number ratio can be appropriately determined by a person skilled in the art in such a way so as to achieve a predetermined composition ratio of the thermosetting resin base and the curing agent in the single-wire multi-core resin cored solder.

The resin cored solder 100c according to the third embodiment is advantageous in that the first flux 11 and the second flux 12 do not come in contact with each other and can be separately held, and in that the resin cored solder 100c is easy to handle, since the latter can be used in the form of a single wire.

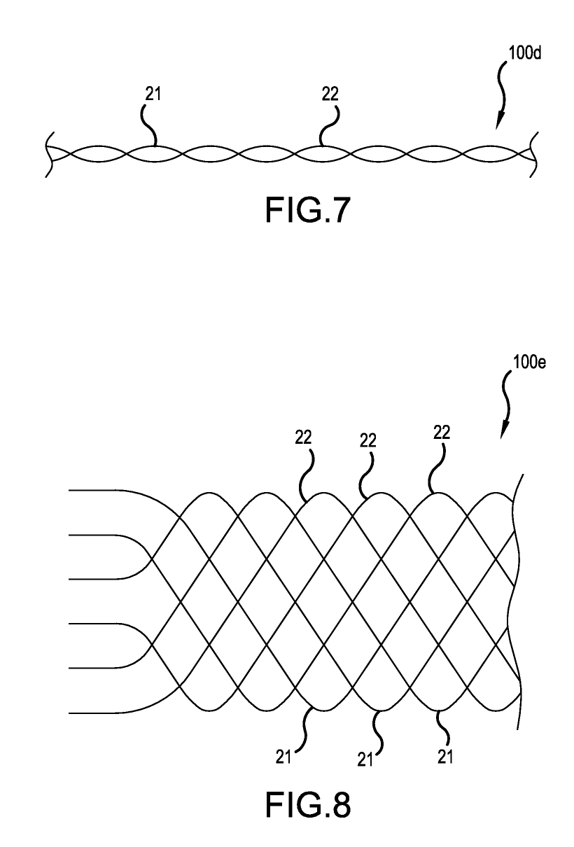

FIG. 7 illustrates a conceptual diagram of a resin cored solder according to a fourth embodiment. The resin cored solder 100d illustrated in FIG. 7 results from twisting the first resin cored solder 21 and the second resin cored solder 22 that are present as individual linear solders.

In the fourth embodiment, the compositions of the first and second fluxes, the composition ratio of the thermosetting resin base and the curing agent, and the respective production methods are as described in the embodiment relating to the fluxes. The first and second resin cored solders that make up the resin cored solder 100d according to the fourth embodiment are as described regarding the solder 100a of the first embodiment.

By way of example, FIG. 7 illustrates the resin cored solder 100d resulting from twisting one wire each of the first resin cored solder 21 and the second resin cored solder 22, but the resin cored solder 100d is not limited to this wire number ratio. The resin cored solder may be obtained by twisting of one wire or a plurality of wires of the first resin cored solder, and one wire or a plurality of wires of the second resin cored solder. The values of the number of wires and of the wire number ratio upon wire twisting are arbitrary, and as many wires of the first resin cored solder 21 and of the second resin cored solder 22 can be twisted, in a mutual wire number ratio, so as to meet an intended purpose.

By virtue of the twisting of the first resin cored solder 21 and the second resin cored solder 22, the present embodiment affords the following advantages. Specifically, the resin cored solder 100d is configured by twisting of the first resin cored solder 21, having the first flux 11 that contains mainly a base of a thermosetting resin built in, and of the second resin cored solder 22, which has the second flux 12 that contains mainly a curing agent having redox activity built in. Therefore, the base and the curing agent can melt and mix simultaneously upon melting of the resin cored solder 100d through heating. The twisted configuration is advantageous in terms of doing away with the need for individually supplying the first resin cored solder 21 and the second resin cored solder 22 in the soldering process. Further, by adjustment of, for instance, the wire number ratio of the first resin cored solder 21 and the second resin cored solder 22 that are twisted together, it becomes possible to supply the resin cored solder 100d at a ratio of the base of a thermosetting resin, such as an epoxy resin, with respect to the curing agent having redox activity, as required for soldering and for eliciting the effect of curing the base of a thermosetting resin. Ordinary resin cored solders in the form of multi-core wires or rolled wires are problematic in that the resin portion of the resin cored solder undergoes thermal modification on account of, for instance, heat generated during production. However, according to the present invention the base of a thermosetting resin and the curing agent do not come into contact until the time of use, and hence it becomes possible to avoid the above problems during production. Further, ordinary single-core or multi-core resin cored solders may be problematic in that, for instance, flux that vaporizes upon abrupt heating of the latter has nowhere to escape, and the flux and/or solder may scatter as a consequence. A twisted configuration is advantageous herein in that the above problem can be suppressed, since gaps are formed at the contact section between the first resin cored solder 21 and the second resin cored solder 22.

FIG. 8 illustrates a conceptual diagram of a resin cored solder according to a fifth embodiment. The resin cored solder 100e illustrated in FIG. 8 results from weaving a plurality of wires of the first resin cored solder 21 and a plurality of wires of the second resin cored solder 22.

In the fifth embodiment, the compositions of the first and second fluxes, the composition ratio of the thermosetting resin base and the curing agent, and the respective production methods are as described in the embodiment relating to the fluxes. The first and second resin cored solders that make up the resin cored solder 100e according to the fifth embodiment are as described regarding the solder 100a of the first embodiment.

The woven resin cored solder contemplated in the present embodiment is explanatory in nature, and the configuration illustrated in the figure is merely an illustrative example of one embodiment. Various linear solders weaving schemes could be grasped and realized herein by a person skilled in the art. Through weaving of the first resin cored solder 21 and the second resin cored solder 22, the present embodiment elicits substantially the same advantages as the twisted configuration described in the fourth embodiment above.

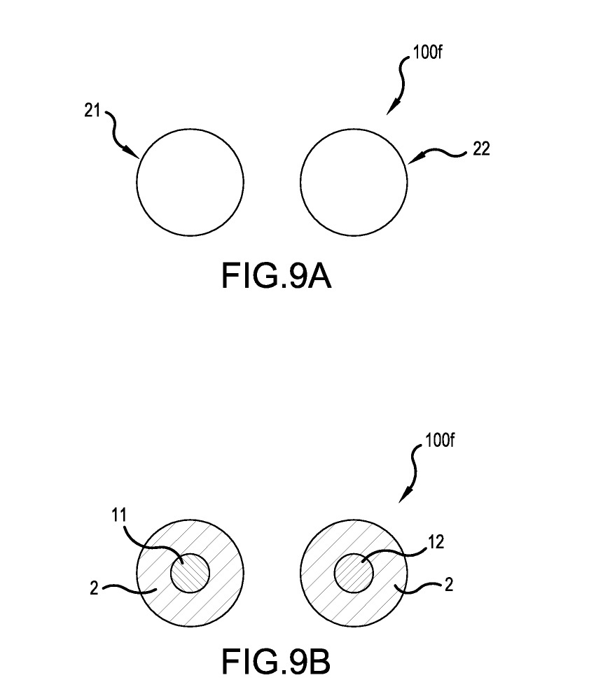

FIG. 9 illustrates a conceptual diagram of a resin cored solder according to a sixth embodiment. A resin cored solder 100f illustrated in FIG. 9 is a spherical solder. As illustrated in FIG. 9A, the surface of a spherical first resin cored solder 21 and a spherical second resin cored solder 22 is covered, substantially or entirely, by the lead-free solder alloy 2, such that the flux is not visible from the outside. FIG. 9B illustrates a cross-sectional diagram of FIG. 9A. In the spherical first resin cored solder 21, the first flux 11 is present at the center of a spherical body, and the lead-free solder alloy 2 covers substantially or entirely the surface of the spherical body. In the spherical second resin cored solder 22 as well, the second flux 12 is present at the center of a spherical body, and the lead-free solder alloy 2 covers substantially or entirely the surface of the spherical body.

In the sixth embodiment, the compositions of the first and second fluxes, the composition ratio of the thermosetting resin base and the curing agent, and the respective production methods are as described in the embodiment relating to the fluxes.

An instance is illustrated herein where the spherical first resin cored solder 21 and the spherical second resin cored solder 22 have identical sizes and volumes of enclosed flux, but the sizes of the two spherical bodies may be dissimilar. Alternatively, the sizes of the spherical bodies may be identical, and the volume and mass of the first flux 11 and the second flux 12 in the interior of the spherical bodies dissimilar. In a case where the spherical first resin cored solder 21 and the spherical second resin cored solder 22 have identical spherical body sizes and volumes of enclosed flux, the first resin cored solder 21 and the second resin cored solder 22 may be used combined in different amounts, as in the case explained regarding the above-described resin cored solder 100b according to an embodiment above. The resin cored solders are not limited to spherical bodies, and may be shaped as granules or rods.

The structural characterizing feature of the resin cored solders according to the first to sixth embodiments of the present invention is that the first flux and the second flux are covered with lead-free solder alloy, and do not come into contact with each other until the time of use. As a result, it becomes possible to enjoy the advantages of a thermosetting resin-based resin cored solder, which differs from conventional rosin-based resin cored solders, while enhancing the storability of the resin cored solder.

### EXAMPLES

The present invention will be explained in detail below with reference to examples. The examples below are merely illustrative examples of the present invention, which is not limited to the examples.

### Resin Cored Solder in an Example

A flux made of an epoxy resin was prepared as a first flux, and a flux made of an organic acid was prepared as a second flux. A first resin cored solder and a second resin cored solder were produced using the first and the second fluxes, respectively, in accordance with an ordinary production method of rosin-based resin cored solders. As the epoxy resin base there were used AER260 (by Asahi Kasei E-materials, bisphenol A epoxy resin, epoxy equivalent 192 g/eq, liquid at normal temperature and normal pressure) in Example 1; YD-011 (by Sumikin Chemical, bisphenol A epoxy resin, epoxy equivalent 500 g/eq, melting point 70° C.) in Example 2; and YD-019 (by Sumikin Chemical, bisphenol A epoxy resin, epoxy equivalent 3300 g/eq, melting point 145° C.) in Example 3. The epoxy resin bases of Examples 2 and 3 were solid at normal pressure. In all three Examples 1, 2 and 3, the compound cis-4-cyclohexene-1,2-dicarboxylic acid (anhydride melting point 98° C.) was used as the organic acid.

In Examples 1 to 3, Sn-3.0Ag-0.5Cu mass % was used as the lead-free solder alloy. The mass ratio of the first flux and the lead-free solder alloy in the linear first resin cored solder (also referred to as base wire) was 5:95 in all the examples above. The mass ratio of the second flux and the lead-free solder alloy in the linear second resin cored (also referred to as curing agent wire) was set such that the equivalent ratio of the epoxy resin used in the base wire and the curing agent used in the curing agent wire was 1:1. The above mass ratio was 2.25:97.75 in Example 1, 0.86:99.14 in Example 2, and 0.13:99.87 in Example 3.

The first and second resin cored solders, which are solid at normal temperature, were produced in accordance with a conventional method with warming at or above the melting point. Both the first and second resin cored solders were drawn to φ0.3, were cut to identical lengths, and one epoxy resin wire corresponding to the first resin cored solder, and one curing agent wire corresponding to the second resin cored solder, were twisted, as illustrated in FIG. 7, to yield a resin cored solder for evaluation.

Table 1 sets out the epoxy resin bases and curing agents that were used, along with the mass ratio per unit length of the epoxy resin contained in the first resin cored solder and the curing agent contained in the second resin cored solder.

The resin cored solders of Examples 1 to 3 thus obtained were tested next for the following four items.

### Evaluation Items and Criteria

(1) Producibility

It was determined whether the resin cored solders could be produced or not in accordance with conventional methods for producing resin cored solders. In the table below, “O” (good) denotes a resin cored solder that can be produced without any problems, “Δ” (fair) denotes a resin cored solder amenable for production, but with flux leakage, and “x” (poor) denotes a non-producible resin cored solder.

(2) Solderability

Soldering was performed using a soldering iron at 350° C. Thereafter, the tip of the iron was placed once more against the soldered section, and the number of times this was done until a spike formed was tallied up, to evaluate solderability. In the table, “O” denotes three or more times, “Δ” denotes from one to three times, and “x” denotes spiking from the outset.

(3) Storage Stability

Changes in properties with the passage of time were evaluated based on the number of days that elapsed while soldering was still possible, in a state where solder was left to stand at normal temperature. In the table, “O” denotes 6 or more months, “Δ” denotes from 1 to 3 months, and “x” denotes less than one month.

(4) Curability

The elastic modulus of the fluxes after soldering was evaluated using a microhardness tester (ENT1100a, by Elionix). In the table, “O” denotes 1 GPa or greater, “Δ” denotes from 0.5 GPa to less than 1 GPa, and “x” denotes less than 0.5 GPa.

### Resin Cored Solder in a Comparative Example

Production of a resin cored solder was attempted using a joint flux composition, without separate production of the first flux and the second flux. Herein, AER260 as the base of the epoxy resin, and the organic acid cis-4-cyclohexene-1,2-dicarboxylic acid were weighed as given in Table 1, the organic acid was added to the epoxy resin, and the whole was heated and mixed. The compounds of the base and the curing agent were identical to those of Example 1. A resin cored solder could not be produced, owing to curing as the crosslinking reactions between the epoxy resin and the organic acid began upon heating and mixing of the epoxy resin and the organic acid. Accordingly, it was not possible to evaluate solderability, storage stability or curability.

The results are given in Table 1.

TABLE 1

| | | Example 1 | | Example 2 | | Example 3 | | |
|---|---|---|---|---|---|---|---|---|
| | | | Curing | | Curing | | Curing | |
| | Material name | | agent | | agent | | agent | Comparative |
| | (product name) | Base wire | wire | Base wire | wire | Base wire | wire | example |
| Epoxy resin | AER260 (liquid) | 69.0 | | | | | | 69.0 |
| | YD-011 | | | 85.3 | | | | |
| | YD-019 | | | | | 97.4 | | |
| Curing agent | cis-4-cyclohexene-1,2- | | 31.0 | | 14.7 | | 2.6 | 31.0 |
| | dicarboxylic acid | | | | | | | |

| | | | | |
|---|---|---|---|---|
| Producibility | Δ | ◯ | ◯ | X |
| Solderability | ◯ | ◯ | ◯ | — |
| Storage stability | X | ◯ | ◯ | — |
| Curability | ◯ | ◯ | ◯ | — |

Thus, a flux for resin cored solder and resin cored solder having the flux for resin cored solder built in have been described according to the present invention. Many modifications and variations may be made to the techniques and structures described and illustrated herein without departing from the spirit and scope of the invention. Accordingly, it should be understood that the fluxes and methods described herein are illustrative only and are not limiting upon the scope of the invention. The flux for resin cored solder according to the present invention, and the resin cored solder having the flux for resin cored solder built in, are preferably used for soldering of electronic components.

### EXPLANATION OF REFERENCE NUMERALS

1 flux for resin cored solder
11 first flux containing a thermosetting resin
12 second flux containing a curing agent
2 lead-free solder alloy
21 first resin cored solder wire
22 second resin cored solder wire
100a resin cored solder according to the first embodiment
100b resin cored solder according to the second embodiment
100c resin cored solder according to the third embodiment
100d resin cored solder according to the fourth embodiment
100e resin cored solder according to the fifth embodiment
100f resin cored solder according to the sixth embodiment

What is claimed is:

1. A flux for resin cored solder, comprising:
a solid-state first flux containing a base of a thermosetting resin; and
a solid-state second flux containing a curing agent having redox activity,
wherein the first flux and the second flux do not contact each other.

2. The flux for resin cored solder according to claim 1, wherein the flux for resin cored solder comprises one or more first flux and one or more second flux.

3. The flux for resin cored solder according to claim 1, wherein the first flux and the second flux are individually covered, at least partially, with a lead-free solder alloy.

4. The flux for resin cored solder according to claim 3, wherein the first flux and second flux are bundled or twisted.

5. The flux for resin cored solder according to claim 1, wherein a melting point of the thermosetting resin ranges from 50 to 150° C.

6. The flux for resin cored solder according to claim 1, wherein the thermosetting resin is an epoxy resin selected from the group consisting of bisphenol A epoxy resins, bisphenol F epoxy resins, novolac epoxy resins, alicyclic epoxy resins, and mixtures thereof.

7. The flux for resin cored solder according to claim 1, wherein the curing agent having redox activity is selected from the group consisting of amines, halogenated amine salts, halogenated organic acid salts, halogen compounds, organic acids, acid anhydrides, phenolic resins, and mixtures thereof.

8. The flux for resin cored solder according to claim 1, wherein an equivalent ratio of the thermosetting resin base and the curing agent ranges from 1:0.8 to 1.3.

9. A resin cored solder containing a flux for resin cored solder comprising a solid-state first flux containing a base of a thermosetting resin and a solid-state second flux containing a curing agent having redox activity, wherein the first flux and the second flux do not contact each other, and a lead-free solder alloy, the resin cored solder comprising one or more first resin cored solders in which the first flux is built into the lead-free solder alloy, and one or more second resin cored solders in which the second flux is built into the lead-free solder alloy.

10. The resin cored solder according to claim 9, wherein the first resin cored solder and the second resin cored solder are separate linear solders.

11. The resin cored solder according to claim 10, wherein the first resin cored solder and the second resin cored solder are bundled, twisted or woven.

12. The resin cored solder according to claim 9, wherein one or more of the first resin cored solders and one or more of the second resin cored solders are fixed at the portions of the lead-free solder alloy, so they form one wire of a multi-core resin cored solder.

13. The resin cored solder according to claim 9, wherein the lead-free solder alloy is a Sn-containing lead-free solder alloy having a melting point ranging from 130 to 250° C.

14. The flux for resin cored solder according to claim 2, wherein the first flux and the second flux are individually covered, at least partially, with a lead-free solder alloy.

15. The flux for resin cored solder according to claim 14, wherein the first flux and second flux are bundled or twisted.

16. The resin cored solder according to claim 10, wherein the lead-free solder alloy is a Sn-containing lead-free solder alloy having a melting point ranging from 130 to 250° C.

17. The resin cored solder according to claim 11, wherein the lead-free solder alloy is a Sn-containing lead-free solder alloy having a melting point ranging from 130 to 250° C.

18. The resin cored solder according to claim 12, wherein the lead-free solder alloy is a Sn-containing lead-free solder alloy having a melting point ranging from 130 to 250° C.

19. The flux for resin cored solder according to claim 2, wherein an equivalent ratio of the thermosetting resin base and the curing agent ranges from 1:0.8 to 1.3.

20. The flux for resin cored solder according to claim 3, wherein an equivalent ratio of the thermosetting resin base and the curing agent ranges from 1:0.8 to 1.3.
